(19) United States
(12) Patent Application Publication
(10) Pub. No.: US 2013/0238480 A1
(43) Pub. Date: Sep. 12, 2013

(54) Dynamic Metals Index Methodology

(71) Applicants: K. Geert Rouwenhorst, New Haven, CT (US); Adam Dunsby, Easton, CT (US); Kurt J. Nelson, Norwalk, CT (US); Ashraf R. Rizvi, New Canaan, CT (US)

(72) Inventors: K. Geert Rouwenhorst, New Haven, CT (US); Adam Dunsby, Easton, CT (US); Kurt J. Nelson, Norwalk, CT (US); Ashraf R. Rizvi, New Canaan, CT (US)

(73) Assignee: SUMMERHAVEN INDEX MANAGEMANT LLC

(21) Appl. No.: 13/665,483

(22) Filed: Oct. 31, 2012

Related U.S. Application Data
(60) Provisional application No. 61/628,417, filed on Oct. 31, 2011.

(51) Int. Cl. G06Q 40/04

(52) U.S. Cl. CPC G06Q 40/04
USPC 705/37

(57) ABSTRACT

A computer-generated dynamic metals index is determined based on inventory states of ten metals consisting of aluminum, copper, zinc, nickel, tin, lead, gold, silver, platinum and palladium and which have been assigned a base weight related to market liquidity and economic importance.

### CROSS-REFERENCE TO RELATED APPLICATION

This application derives from U.S. Provisional Application Ser. No. 61/628,417, filed Oct. 31, 2011, the contents of which are incorporated herein by reference and the priority of which is hereby claimed.

### BACKGROUND OF INVENTION

### Field of the Invention

This invention relates to the determination, using a computer, of a dynamic metals index that is of value to investors in making decisions regarding investing in metal commodities.

### SUMMARY OF THE INVENTION

The inventive metals index is a metal sector index designed to broadly represent industrial and precious metals while overweighting the components that are assessed to be in a low inventory state and underweighting the components assessed to be in a high inventory state. The inventive metal index is called the SummerHaven Dynamic Metals Index (SDMI).

The SDMI consists of ten metals—six base metals and four precious metals. The base metals are aluminum, copper, zinc, nickel, tin and lead. The precious metals are gold, silver, platinum, and palladium. Each metal is assigned a base weight based on an assessment of the market liquidity and the metal's overall economic importance.

Academic research by Professors Gorton, Rouwenhorst and Hayashi has shown that commodities in relatively low inventory states \ tend to have higher turns than commodities in relatively high inventory states. Furthermore, relative inventory comparisons can be estimated by the price-based signals momentum and basis. Momentum is the percentage price change in a commodity over the previous year. Basis is the annualized percentage difference between the nearest-to-maturity contract and the second nearest-to-maturity contract. Using these price-based signals, metals determined to be in low inventory state will be weighted more heavily, and metals in high inventory state will be weighted less heavily during any given month.

The SDMI is rules-based and is rebalanced monthly based on observable price signals described above. In this context, the term “rules-based” is meant to indicate that the composition of the SDMI in any given month will be determined by quantitative formulas relating to the prices of the future contracts that relate to the commodities that are included in the SDMI. Such formulas are not subject to adjustment based on other factors.

The overall return on the SDMI is generated by two components: (i) uncollateralized returns from the Benchmark Component Metals Futures Contracts comprising the SDMI, and (ii) a daily fixed income return reflecting the interest earned on a hypothetical 3-month U.S. Treasury Bill collateral portfolio, calculated using the weekly auction rate for the 3-month U.S. Treasury Bills published by the U.S. Department of the Treasury.

Table 1 below lists the eligible metals, the relevant Futures Exchange on which each Benchmark Component Metals Futures Contract is listed and quotation details. Table 2 lists the Benchmark Component Metals Futures Contracts, their sector designation and maximum allowable tenor.

TABLE 1

| Commodity | Designated Contract | Exchange | Units | | Quote |
|---|---|---|---|---|---|
| Aluminum | High Grade Primary Aluminum | LME | 25 | metric tons | USD/metric ton |
| Copper | Copper | COMEX | 25,000 | lbs. | U.S. cents/lbs. |
| Lead | Lead | LME | 25 | metric tons | USD/metric ton |
| Nickel | Primary Nickel | LME | 6 | metric tons | USD/metric ton |
| Tin | Tin | LME | 5 | metric tons | USD/metric ton |
| Zinc | Special High Grade Zinc | LME | 25 | metric tons | USD/metric ton |
| Gold | Gold | COMEX | 100 | troy oz. | USD/troy oz. |
| Silver | Silver | COMEX | 5,000 | troy oz. | U.S. cents/troy oz. |
| Platinum | Platinum | NYMEX | 50 | troy oz. | USD/troy oz. |
| Palladium | Palladium | NYMEX | 100 | troy oz. | USD/troy oz. |

TABLE 2

| Commodity | Commodity | | |
|---|---|---|---|
| Name | Symbol | Allowed Contracts | Max. Tenor |
| Aluminum | LA | All 12 calendar months | 12 |
| Copper | HG | All 12 calendar months | 12 |
| Lead | LL | All 12 calendar months | 7 |
| Nickel | LN | All 12 calendar months | 7 |
| Tin | LT | All 12 calendar months | 7 |
| Zinc | LX | All 12 calendar months | 7 |
| Gold | GC | February, April, June, August, | 12 |
| | | October, December | |
| Silver | SI | March, May, July, September, | 5 |
| | | December | |
| Platinum | PL | January, April, July, October | 5 |
| Palladium | PA | March, June, September, | 5 |
| | | December | |

Prior to the end of each month, the composition and the values of the SDMI are computed and disseminated approximately every fifteen (15) seconds from 8:00 a.m. to 5:00 p.m., New York City time, and a daily SDMI value is published at approximately 5:30 p.m., New York City time, under the index ticker symbol SDMI TR. Only settlement and last-sale prices are used in the SDMI's calculation, bids and offers are not recognized; including limit-bid and limit-offer price quotes. Where no last-sale price exists, typically in the more deferred contract months, the previous days' settlement price is used. This means that the underlying SDMI may lag its theoretical value. This tendency to lag is evident at the end of the day when the SDMI value is based on the settlement prices of the Benchmark Component Metals Futures Contracts, and explains why the underlying SDMI often closes at or near the high or low for the day.

### Contract Expirations

Because the SDMI is comprised of actively traded contracts with scheduled expirations, it can be calculated only by reference to the prices of contracts for specified expiration, delivery or settlement periods, referred to as contract expirations. The contract-expirations included in the SDMI for each commodity during a given year are designated by SummerHaven Indexing, provided that each contract must be an active contract. An active contract for this purpose is a liquid, actively-traded contract expiration, as defined or identified by the relevant trading facility or, if no such definition or identification is provided by the relevant trading facility, as defined by standard custom and practice in the industry.

If a Futures Exchange ceases trading in all contract expirations relating to a particular Benchmark Component Metals Futures Contracts, SummerHaven Indexing may designate a replacement contract on the particular metal. The replacement contract must satisfy the eligibility criteria for inclusion in the SDMI. To the extent practicable, the replacement will be effected during the next monthly review of the composition of the SDMI.

If a Benchmark Component Metals Futures Contract is eliminated and there is no replacement contract, the underlying metal will necessarily drop out of the SDMI. The designation of a replacement contract, or the elimination of a metal from the SDMI because of the absence of a replacement contract, could affect the value of the SDMI, either positively, depending on the price of the contract that is eliminated and the prices of the remaining contracts. It is impossible, however, to predict the effect of these changes, if they occur, on the value of the SDMI.

### Commodity Weighting

Each of the Benchmark Component Metals Futures Contracts will remain in the SDMI from month to month. Weights for each of the Benchmark Component Metals Futures Contracts are determined for the next month. The methodology used to calculate the SDMI weighting is based solely on quantitative data using observable futures prices and is not subject to human bias.

The monthly weighting selection is a three-step process based upon examination of the relevant futures prices for each metal:

1) The annualized percentage price difference between the closest-to-expiration Benchmark Component Metals Futures Contract and the next closest-to-expiration Benchmark Component Futures Contracts is calculated for each of the 10 eligible metals on the Selection Date. The three metals with the highest percentage price difference are selected. A hypothetical example is included below, with the three selected commodities shaded below (the selected metals are ranked 1-3):

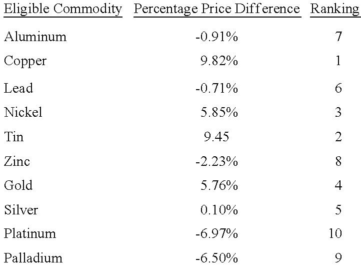

2) For the remaining seven eligible metals, the percentage price change of each metal over the previous year is calculated, as measured by the change in the price of the closest-to-expiration Benchmark Component Metals Futures Contracts on the Selection Date from the price of the closest-to-expiration Benchmark Component Metals Futures Contract a year prior to the Selection Date. The two metals with the highest percentage price change are selected. A hypothetical example is included below, with the next two selected metals shaded below (the selected metals are ranked 1-2):

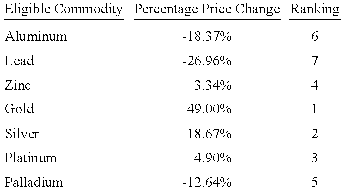

3) for the five metals selected through basis (step 1) and momentum (step 2), each metal's weight is increased by 3% above its base weighting for the following month. For the remaining five metals not selected, each metal's weight is decreased by 3% below its base weighting for the following month. A hypothetical example is included below, with the five selected metals shaded below.

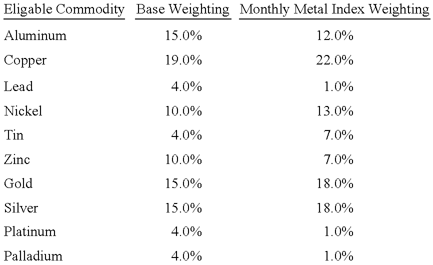

Due to the dynamic monthly metal weighting calculation, the individual metal weights will vary over time, depending on the price observations each month. The Selection Date for the SDMI is the fifth business day prior to the first business day of the next calendar month.

### Contract Selection

For each metal in the SDMI, the index selects a specific Benchmark Component Metals Futures Contract with a tenor (i.e., contract month) among the eligible tenors (the range of contract months) based upon the relative prices of the Benchmark Component Metals Futures Contract within the eligible range of contract months. The previous notwithstanding, the contract expiration is not changed for the month if a Benchmark Component Metals Futures Contract remains in the SDMI, as long as the contract does not enter expire or enter its notice period in the subsequent month.

### Portfolio Construction

The portfolio rebalancing takes place during the Rebalancing Period. At the end of each of the days in the Rebalancing Period, one fourth of the prior month portfolio positions are replaced by the new metals weights for the Benchmark Component Metals Futures Contract determined on the Selection date.

### Metals Index Return Calculation

The percentage excess return equals the percentage change of the market values of the underlying Benchmark Component Metal Futures Contracts. During the Rebalancing Period, the SDMI changes its contract holdings and weightings during a four day period.

The value of the SDMI Excess Return (“SDMI ER”) at the end of a business day “t” is equal to the SDMI ER value on day “t−1” multiplied by the sum of the daily percentage price changes of each commodity future factoring in each respective commodity future's notional holding on day “t−1”.

### Rebalancing Period

The SDMI is rebalanced during the last 4 business days of each calendar month, when existing positions are replaced by new positions and weightings based on the signals based on the signals used for contract selection as outlined above.

### Total Return Calculation

The value of the SDMI Total Return (“SDMI TR”) on any business day is equal to the product of (i) the value of the SDMI TR on the immediately preceding business day multiplied by (ii) one plus the sum of the day's SDMI ER returns and one business day's interest from the hypothetical Treasury Bill portfolio. The value of the SDMI TR is calculated and published.

### Metals Index Base Level

The SDMI TR was set to 100 on Jan. 2, 1991.

### BRIEF DESCRIPTION OF THE DRAWINGS

FIG. 1 shows the metal weights of the metals selected for inclusion in the SDMI as of November 2010, and

FIGS. 2a, 2b and 3a-3e represent example calculations of SDMI.

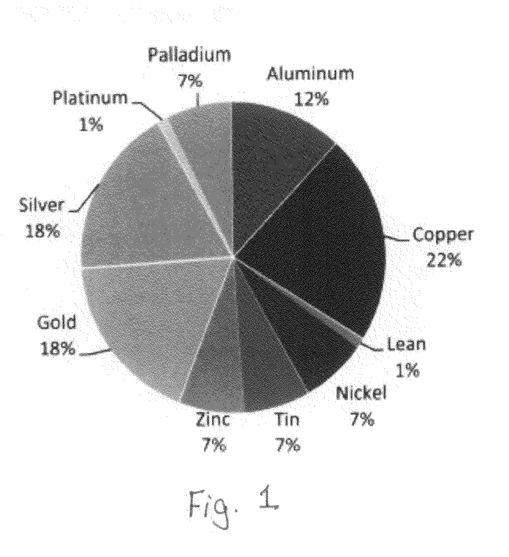

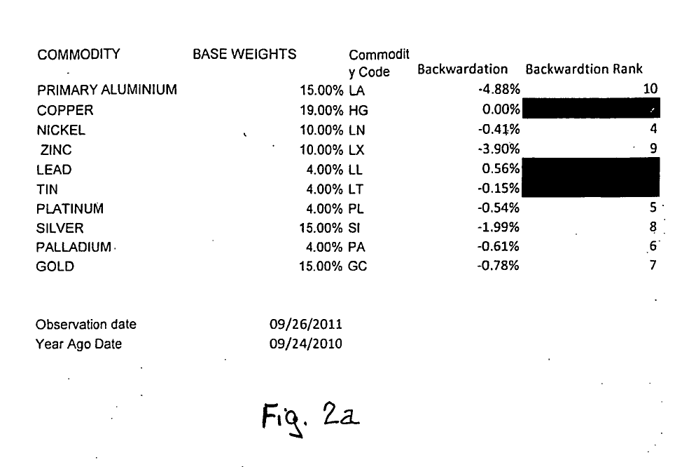

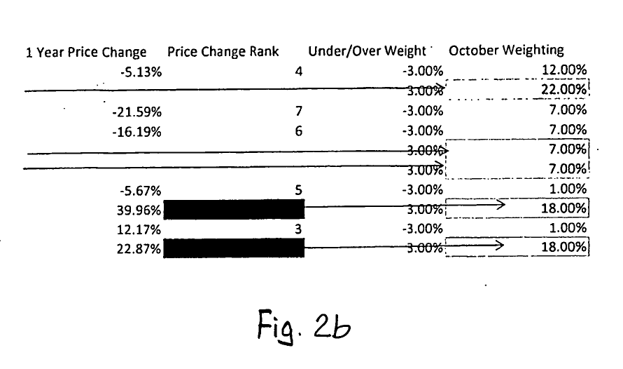

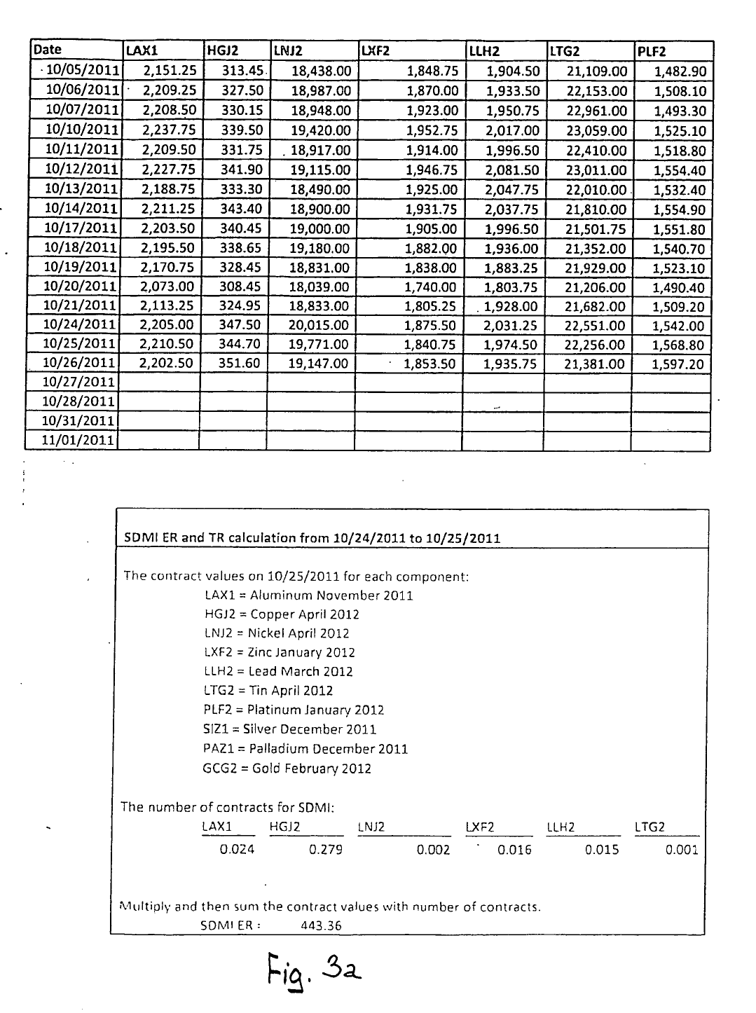

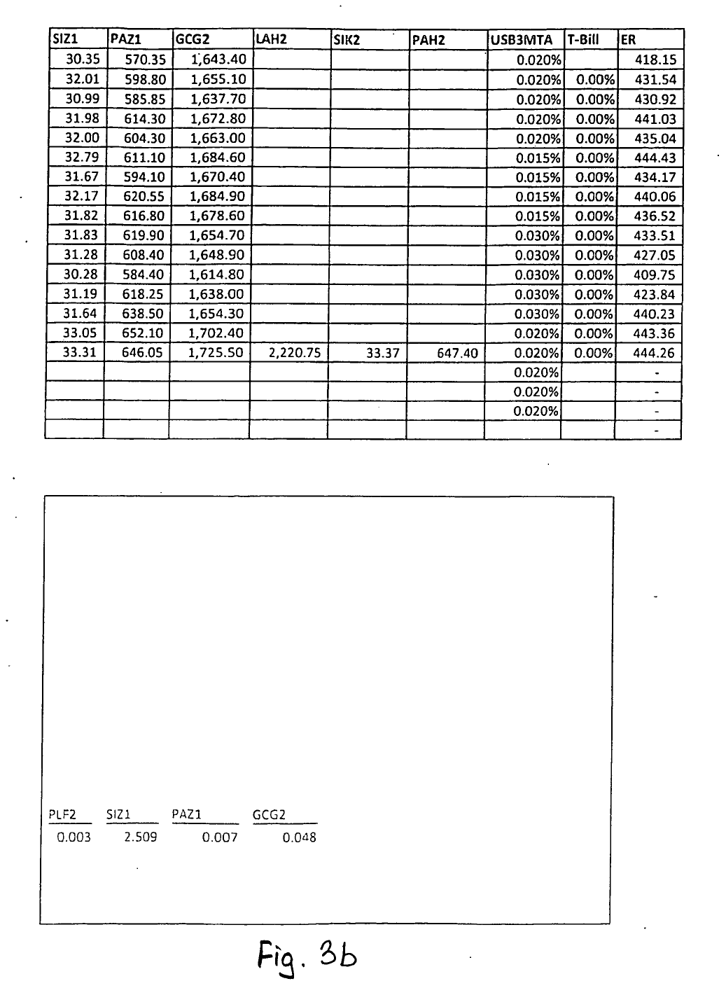

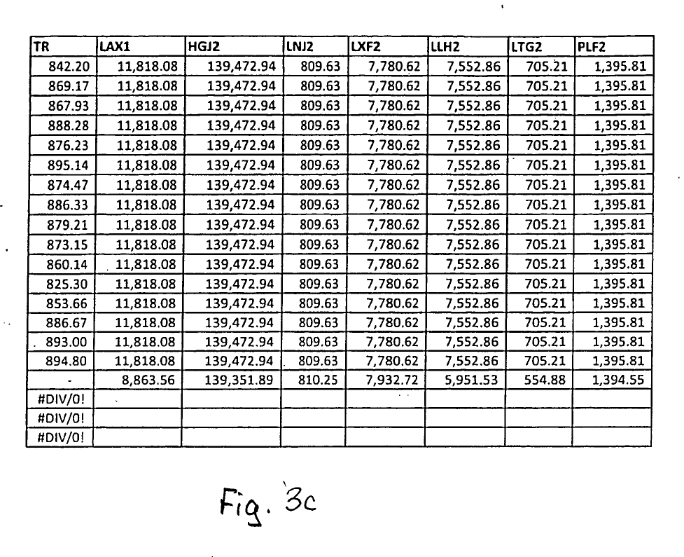

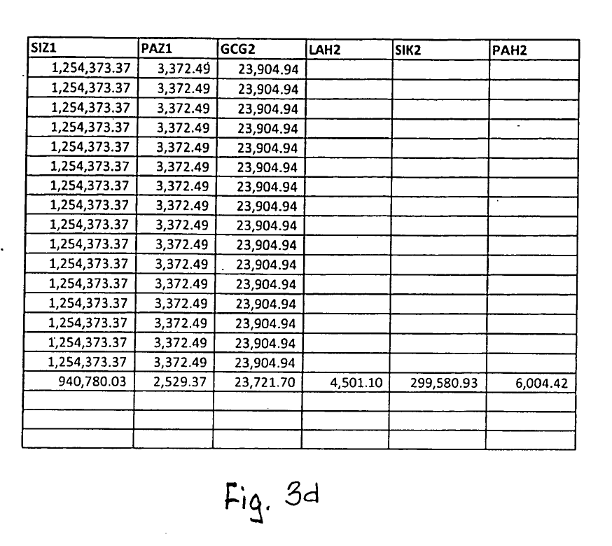

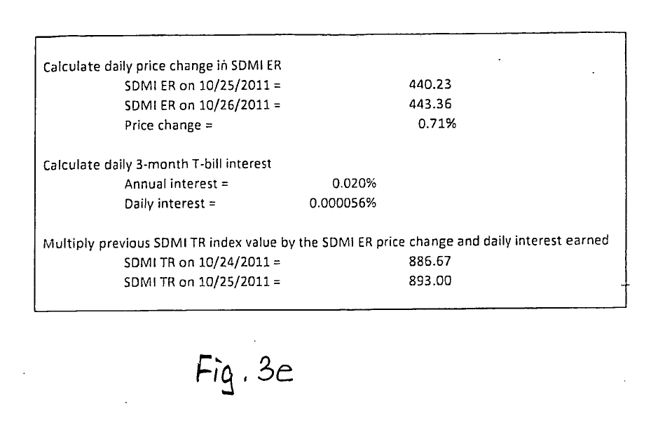

We claim:

1. A method, using a computer, of providing a metal commodity index for investors which comprises the steps of:
(a) determining the annualized percentage price difference between the futures price for the closest-to-expiration contract and the next closest-to-expiration contract for each of the ten eligible metals in the group of aluminum, copper, lead, nickel, tin, zinc, gold, silver, platinum and palladium,
(b) selecting the three metals from said ten eligible metals which have the highest percentage price difference,
(c) from the remaining seven metals, choosing two with the greatest 12-month percentage price difference between the futures price for the closest-to-expiration contract and the closest-to-expiration contract 12-months earlier,
(d) starting from a base weighting as set forth in the following Table 1,

| ELIGIBLE METALS | BASE WEIGHTING |
|---|---|
| Aluminum | 15.0% |
| Copper | 19.0% |
| Lead | 4.0% |
| Nickel | 10.0% |
| Tin | 4.0% |
| Zinc | 10.0% |
| Gold | 15.0% |
| Silver | 15.0% |
| Platinum | 4.0% |
| Palladium | 4.0% |

increasing the weighting of the five selected metals from steps (b) and (c) by 3% and decreasing the weighting of the five remaining metals by 3%,
(e) for each of the 10 metals, selecting the contract month with the greatest backwardation, taking into account the allowed contracts and maximum tenor from the following Table 2:

| COMMODITY | COMMODITY | | MAX. |
|---|---|---|---|
| SYMBOL | NAME | ALLOWED CONTRACTS | TENOR |
| LA | Aluminum | All 12 calendar months | 12 |
| HG | Copper | All 12 calendar months | 12 |
| LL | Lead | All 12 calendar months | 7 |
| LN | Nickel | All 12 calendar months | 7 |
| LT | Tin | All 12 calendar months | 7 |
| LX | Zinc | All 12 calendar months | 7 |
| GC | Gold | February, April, June, August, | 12 |
| | | October, December | |
| SI | Silver | March, May, July, | 5 |
| | | September, December | |
| PL | Platinum | January, April, July, October | 5 |
| PA | Palladium | March, June, September | 5 |
| | | December | |

(f) determining an Excess Return, and
(g) determining a Total Return by multiplying the value of the Excess Return on the preceding business day by one plus the sum of the days excess returns and one day's interest from a hypothetical U.S. Treasury Bill portfolio calculated using the weekly Auction Rate for 3-month U.S. Treasury Bills.
